(19) United States
(12) Patent Application Publication
(10) Pub. No.: US 2006/0264090 A1
(43) Pub. Date: Nov. 23, 2006

(54) Electrical connector assembly and method of forming the same

(76) Inventors: William V. Dower, Austin, TX (US); Jerome A. Pratt, Round Rock, TX (US)

Correspondence Address: 3M INNOVATIVE PROPERTIES COMPANY, PO BOX 33427, ST. PAUL, MN, 55133-3427, US

(21) Appl. No.: 11/131,639

(22) Filed: May 18, 2005

(51) Int. Cl. H01R 4/24

(52) U.S. Cl. 439/404

(57) ABSTRACT

An electrical connector assembly comprises a connector block, which includes a plurality of housing assemblies aligned in a generally vertically stacked orientation. Each housing assembly comprises a housing, an insulation displacement connector element disposed within the housing, where the insulation displacement connector element is adapted to electrically connect with a conductor partially disposed within the housing, an access cover, where the access cover is connected to the housing and is moveable between a closed position and an open position, wherein in the open position, the insulation displacement connector disposed within the housing is accessible, a generally vertical surface, and a conductor-receiving opening along the generally vertical surface.

### FIELD

The present invention relates to an electrical connector assembly. More particularly, the present invention relates to an electrical connector assembly including an insulation displacement connector block (“connector block”) comprising a plurality of housing assemblies, where the housing assemblies are stacked in a generally vertical orientation. The present invention also relates to a method of forming an electrical connector assembly that includes housing assemblies stacked in a generally vertical orientation.

### BACKGROUND

In a telecommunications context, electrical connector blocks are connected to cables that feed subscribers while other electrical connector blocks are connected to cables that are connected to the service provider. To make the electrical connection between the subscriber block and the service provider block, an electrical conductor (e.g., a jumper wire) may be inserted in the electrical connector blocks to complete the electrical circuit. This process of connecting two connector blocks is generally known as “cross-connecting”. Typically the electrical conductor can be connected, disconnected, and reconnected several times as the consumer's needs change.

The basic components of a typical connector block typically include a housing, an IDC element disposed within the housing, and a conductor-receiving opening for introducing an electrical conductor (which is typically insulated) into the housing. The IDC element is used to make an electrical connection with the conductor so that the electrical circuit between the subscriber block and service provider block is completed. The IDC element displaces the insulation from a portion of the conductor when the conductor is inserted into a slot within the IDC element. An electrical contact is then made between the conductive surface of the IDC element and the conductive core of the electrical conductor. The IDC element thereby forms a portion of a circuit path by making an electrical connection with the conductor.

When a connector block is used in the telecommunications context, the connector block is typically mounted in a central location, such as a telecommunications closet, along with a plurality of other connector blocks. It is desirable for each connector block to be mounted in a position that allows a telecommunications worker to access to the openings in connector block in order to feed a conductor into the housing, and to the IDC elements, in order to make the necessary electrical connections.

### BRIEF SUMMARY

In a first aspect, the present invention is an electrical connector assembly comprising a connector block. The connector block includes a plurality of housing assemblies aligned in a generally vertically stacked orientation. Each housing assembly comprises a housing, an insulation displacement connector element disposed within the housing, an access cover connected to the housing, a generally vertical surface, and a conductor-receiving opening along the generally vertical surface of the housing assembly. The insulation displacement connector element is adapted to electrically connect with a conductor partially disposed within the housing. The access cover is moveable between a closed position and an open position, where in the open position, the insulation displacement connector is accessible,

In a second aspect, the present invention is an assembly for connecting at least two electrical conductors. The assembly comprises a frame, a first insulation displacement connector block including a first elongated edge, and a second insulation displacement connector block including a second elongated edge. The first insulation displacement connector block is attached to the frame such that the first elongated edge extends in a generally vertical direction. The second insulation displacement connector block is attached to the frame such that the second elongated edge extends in the generally vertical direction. The first elongated edge of the first connector block is generally parallel to the second elongated edge of the second connector block.

In a third aspect, the present invention is a method of forming an electrical connector assembly. The method comprises providing a first connector block, providing a frame for receiving the first connector block, and attaching the first connector block to the frame. The first connector block includes a first generally vertical surface, a conductor-receiving opening along the first generally vertical surface of the housing, a plurality of housings aligned in a generally vertically stacked orientation, an insulation displacement connector element disposed within each housing, where the insulation displacement connector element is adapted to electrically connect with a conductor partially disposed within each respective housing, and an access cover on the housing which is moveable between a closed position and an open position, where in the open position, the insulation displacement connector is accessible.

The above summary is not intended to describe each disclosed embodiment or every implementation of the present invention. The figures and the detailed description which follow more particularly exemplify illustrative embodiments.

### BRIEF DESCRIPTION OF THE DRAWINGS

The present invention will be further explained with reference to the drawing figures listed below, where like structure is referenced by like numerals throughout the several views.

FIG. 1 is a perspective view of an electrical connector assembly, where a connector block is mounted on a frame, such as in a telecommunications closet. The connector block includes a plurality of housings aligned in a generally horizontal direction.

FIG. 2 is a perspective view of an exemplary embodiment of an electrical connector assembly in accordance with the present invention, which includes a connector block that is mounted on a frame. The connector block includes a plurality of housings and is mounted on the frame so that the housings are aligned in a generally vertically stacked orientation.

FIG. 3 is a perspective view of the electrical connector assembly of FIG. 2, where two connector blocks are aligned adjacent one another so that generally vertical surfaces of each connector assembly are generally parallel.

While the above-identified figures set forth an exemplary embodiment of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION

The present invention is an electrical connector assembly including a connector block, where the connector block includes a plurality of housing assemblies aligned in a generally vertically stacked orientation. A plurality of conductor-receiving openings (“openings”) are positioned along a generally vertical wall of the connector block. Each of the housing assemblies includes at least one corresponding opening, which provides a means of introducing a conductor into a housing of the housing assembly. The present invention also includes a method of forming an electrical connector assembly that includes housing assemblies stacked in a generally vertical orientation.

In an exemplary embodiment of the present invention, each housing assembly includes a housing and an access cover. An IDC element is disposed within the housing. The IDC element is adapted to electrically connect with a conductor that is at least partially disposed within the housing. The access cover is connected to the housing and moveable between a closed position and an open position. In the open position, an IDC element that is disposed within the connected housing is accessible.

Each housing assembly also includes a generally vertical surface and a conductor-receiving opening positioned along the generally vertical surface. A conductor may be introduced into the housing of the housing assembly through the conductor-receiving opening. Because the housing assemblies of the connector block are aligned in a generally vertically stacked orientation, the plurality of conductor-receiving openings of the connector block are aligned along the vertical surface of the connector block.

In the exemplary embodiment described herein (“first embodiment”), each housing of the plurality of housing assemblies has a generally vertical surface. In that embodiment, the generally vertical housing surfaces are aligned in a generally vertical direction to form the generally vertical surface of the connector block. In the first embodiment, which is described herein, a conductor-receiving opening of each housing assembly is on a generally vertical surface of a housing.

In an alternate embodiment (“second embodiment”), each access cover of the plurality of housing assemblies has a generally vertical surface, and the generally vertical surface of the connector block may be formed by a plurality of generally vertical access cover surfaces aligned in a generally vertical direction. In the second embodiment, the conductor-receiving opening of each housing assembly is on a generally vertical surface of the access cover of the housing assembly. In yet another alternate embodiment, a generally vertical surface of the connector block is mutually independent of the generally vertical surface of a housing assembly mounted in the connector block.

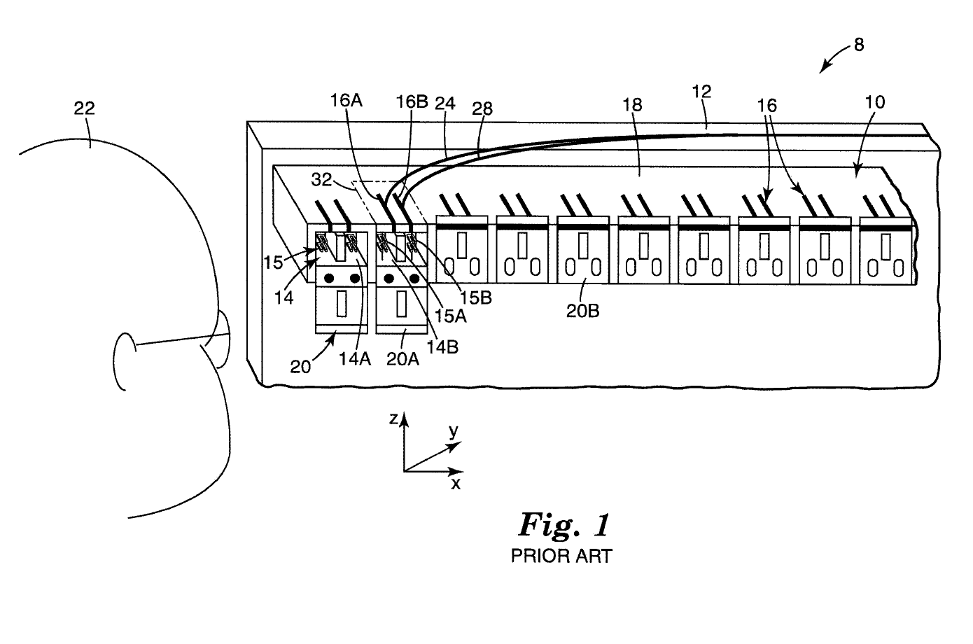

The modifier, “generally”, is meant to convey that “generally vertical” includes more than a strictly vertical direction (i.e., a z-coordinate direction, where orthogonal x-y-z coordinates are shown in FIG. 1), and “generally horizontal” includes more than a direction strictly 90 degrees to the vertical direction (i.e., in orthogonal x or y-coordinate directions). As used hereinafter throughout the description of the present invention, “vertical” shall mean “generally vertical” and “horizontal” shall mean “generally horizontal”.

Throughout the detailed description of the present invention, “top”, “bottom”, and “side” are defined according to conventional meaning. A “top” of a connector block is the surface of the connector block having the greatest z-coordinate when the connector block is mounted in a central location (e.g., a telecommunications closet), a “bottom” of the connector block is the surface of the connector block having the smallest z-coordinate when the connector block is mounted in the central location, and a “side” is a surface of the connector block running vertically between the top and bottom.

The number of housing assemblies a connector block includes varies depending on many factors, including the dimensional parameters of the central location in which the connector block is to be mounted. In the telecommunications industry, the connector blocks are typically referred to by the number of pairs of conductors the connector block is capable of connecting (e.g., the number of circuit paths the connector block is capable of forming). A common connector block in the telecommunications industry is a ten-pair block, which is capable of being connected to up to ten pairs of conductors (e.g., telecommunication conductors that are electrically connected to a service provider or to ten pairs of telecommunication conductors that are electrically connected to a subscribers). Jumper wires can be used to complete the connection between these blocks. While ten pair blocks are illustrated in FIGS. 1-3, any suitable connector block may be used in accordance with the present invention.

A plurality of connector blocks are typically mounted in a central location, such as a telecommunications closet. The number of connector blocks in the central location depends upon the needs of the telecommunications network. The central location is typically located in an area where a telecommunications worker is able to access it in order to connect and disconnect service provider and customer circuits as needed.

Within each central location, each connector block must be mounted in a position that allows the telecommunications worker to access to the openings and IDC elements so that the worker may make the necessary electrical connections. In one of the present methods of mounting a connector block, the connector block is mounted so that a conductor-receiving opening of a housing assembly is positioned at the top of the housing, along a horizontal wall of the housing. This type of positioning is illustrated in FIG. 1, which shows electrical connector assembly 8, which includes connector block 10 mounted on frame 12. Frame 12 is a general representation of a frame that may be used to mount connector block 10 in the central location, and is not intended to limit the present invention in any way. In order to provide a reference point for gauging the horizontal and vertical direction, an orthogonal x-y-z coordinate system is shown in FIG. 1 along with a depiction of person 22, who is looking at electrical connector assembly 8.

Connector block 10 includes housings 14, openings 16, horizontal wall 18, and access covers 20. Each housing assembly of connector block 10 is defined by a housing of the plurality of housings 14 and a respective access cover of the plurality of access cover 20. “Housings 14” generally refers to the plurality of housings in connector block 10 and “openings 16” generally refers to the plurality of openings in connector block 10. Housings 14 include housing 14A and housing 14B, whose access covers 20 are each in an open position 20A so that two IDC elements 15 disposed in each housing 14A and 14B are exposed. Although housings 14A and 14B house two IDC elements 15 each, housings 14A and 14B, as well as the other housings 14, may each have any suitable number of IDC elements. Only two access covers 20 are shown in an open position 20A and as a result, only the interiors of two housings 14A and 14B are visible.

Housings 14, and therefore the housing assemblies, are aligned in the horizontal direction (i.e., in FIG. 1, the x-coordinate direction) so that connector block 10 is elongated in the horizontal direction. That is, the length connector block 10 extends along the horizontal direction and connector block 10 has a greater dimension in the horizontal direction than in the vertical dimension.

In electrical connector assembly 8 shown in FIG. 1, two openings 16 correspond to each housing 14. Openings 16, which include openings 16A and 16B, are each configured to be able to receive at least one conductor. When a conductor is introduced into opening 16A, the conductor may access IDC element 15A in housing 14B, and likewise, when a conductor is introduced into opening 16B, the conductor may access IDC element 15B in housing 14B. Each one of openings 16 is positioned at a top surface of each respective housing 14. The top surface of each one of housings 14 is aligned to form horizontal wall 18 of connector block 10. As a result, openings 16 are aligned along a horizontal wall 18 of connector block 10.

A telecommunications worker may need to have access to openings 16 because when the worker is making the necessary electrical connections using connector block 10, the worker may need to manually feed a conductor through an opening in plurality of openings 16 in order to access an IDC element disposed within the respective housing of the opening, which makes the electrical connection with the conductor. In the central location, connector block 10 may be located at or near the bottom of a row of connector blocks, near the ground or the bottom surface of the central location; if openings 16 are located along the bottom of connector block 10, the telecommunications worker may find it difficult to access and view openings 16 if they are close to the ground (or the bottom surface of the central location) because the worker may need to lie on the ground (or be in a position close to the ground) in order to view and/or access openings 16. There may even be potential visibility problems with the mounting of connector block 10 in FIG. 1, where openings 16 are aligned along a top of connector block 10. If a telecommunications worker is not tall enough to view the top of connector block 10, it may be difficult for the worker to make the necessary electrical connections.

Conductor 24 is received in opening 16A and connected to IDC element 15A, which is disposed in housing 14B, and conductor 28 is received in opening 16B and connected to an IDC element 15B, which is also disposed in housing 14B. Conductors 24 and 28 are only partially disposed in housing 14B because only an end portion of each conductor 24 and 28 is disposed in housing 14B and connected to IDC elements 15A and 15B, respectively, and a portion of each conductor 24 and 28 extends from housing 14B. Conductors 24 and 28 extend from housing 14B in a vertical and upward direction (see area 32 in FIG. 1). Conductors 24 and 28 may eventually extend in a downward direction because as understood by those skilled in the art, the typical practice of a telecommunications worker when making cross connections between a subscriber block and a service provider block in the central location is to route conductors 24 and 28 so that the low point (i.e., smallest z-coordinate) of each conductor 24 and 28 is found somewhere in the middle of the conductor 24 and 28, not at either end connected to either connector block. For example, conductors 24 and 28 may be routed to the bottom of the central location before being routed to another connector block.

Access covers 20 are pivotally connected to their respective housing 14, and access covers 20 pivot along a common horizontal axis. The pivotal connection may be a hinge. Each of the plurality of access covers 20 has an open position 20A and closed position 20B. In order to move between closed position 20B and open position 20A, each of the access covers 20 pivots in a downward direction. When each of the plurality of access covers 20 is in an open position, IDC elements 15, which are disposed within each housing 14 may be accessible by the telecommunications worker.

The present invention recognizes that when electrical connector assembly 8 is mounted in a central location that is not climate or humidity controlled, there is a potential for moisture to accumulate in area 32, where conductors 24 and 28 enter (or exit) openings 16A and 16B, respectively, and extend from housing 14B. The present invention further recognizes that conductors 24 and 28 may provide a path for moisture to enter housing 14B through openings 16A and 16B, respectively, when conductors 24 and 28 extend from housing 14B in the vertical and upward direction. In this way, conductors 24 and 28 may each act as a “wick”. For example, moisture that has accumulated around area 32 may run down conductors 24 and 28 (as a result of gravity) and directly into openings 16A and 16B, respectively, thereby introducing water into housing 14B. Openings 16A and 16B (as well as openings 16 in general) may be larger than necessary to receive conductors 24 and 28, and so, there may be space for moisture to penetrate through openings 16A and 16B, even with conductors 24 and 28 moving through openings 16A and 16B. In this way, openings 16A and 16B (and openings 16 in general) are a housing entry point for moisture. Moisture may also be introduced into housing 14B directly through openings 16A and 16B without the assistance of “wicking” conductors 24 and 28. It is typically preferred that as little moisture enter each housing 14 as possible, whether or not there is an electrical connection in each housing 14, due to the deleterious effects of water on electrical connection points and conductors.

If connector block 10 of electrical connector assembly 8 were rotated 180 degrees such that openings 16 were aligned along the bottom of connector assembly 8, conductors 24 and 28 would extend from housing 14B in a downward direction. While this positioning of connector block 10 may help address the potential for moisture to be introduced into housing 14B because of the “wicking” affect, it may introduce another problem. When openings 16 are aligned along a bottom of connector block 10, a telecommunications worker may have difficulty accessing and viewing openings 16.

Another potential problem that may arise if connector block 10 of electrical connector assembly 8 were rotated 180 degrees is that the connection point between each one of housings 14 and its respective access cover 20 would be positioned at the top of connector block 10. Moisture that accumulates along the top surface of connector block 10 may penetrate through the connection point between each one of housings 14 and its respective access cover 20 to thereby enter the respective housing. In this way, the connection point between each one of housings 14 and its respective access cover 20 may also act as a housing entry point.

A gel or other sealant material may be added to each one of housings 14 prior to the closure of its respective access cover 20 to create a moisture seal within the housing when the access cover closed. While a sealant material helps minimize the amount of moisture that contacts the IDC element 15 disposed within each one of the housings 14 after the moisture enters the housing 14, the present invention helps to further minimize the amount of moisture that enters the housing.

Because moisture is likely to accumulate along the top surface of a connector block when it is mounted in a central location, there is a need for a connector block assembly that has fewer housing entry points (as compared to connector block 10 of electrical connector assembly 8) along the top surface of the connector block. Fewer openings along the top surface will help to minimize the amount of moisture that may enter each one of housings 14 due to moisture penetrating through a housing entry point. A housing entry point may be any conductor-receiving opening, connection point between an access cover and housing, or any other channel that leads into each housing.

While electrical connector assembly 8 makes tremendous improvements in the art of electrical connector assemblies and may be designed such that it does not introduce enough water into housing 14 to be problematic, the present invention provides a further improvement. The present invention helps to further minimize the possibility that excess moisture may enter a housing of a connector block, through a “wicking” conductor or otherwise.

In part, the present invention minimizes the amount of moisture that may potentially be introduced into a housing of the connector block by way of openings and/or a path created by a conductor. In the present invention, it is preferred that a conductor, which is received in the opening of the housing, extends from its respective housing in a horizontal and downward direction. The horizontal and downward extension of the conductor from the housing helps to minimize the possibility that moisture that condenses around the conductor will be introduced into the housing. Compared to conductors 24 and 28 of electrical connector assembly 8 (shown in FIG. 1), a conductor that extends from its respective housing in a horizontal and downward direction minimizes the potential for water to wick into the housing by way of the conductor.

The present invention also minimizes the amount of moisture that may potentially be introduced into a housing of the connector block by minimizing the number of housing entry points positioned along the top surface of the connector block (where moisture may accumulate) when it is mounted in a central location. In the exemplary embodiment, the top surface of the connector block does not have any entry points for the moisture (conductor-receiving openings or otherwise) to enter the housing, and the top surface is preferably monolithic. Furthermore, in the exemplary embodiment, the top surface of the connector block has a smaller area than in the top surface of connector block 10, thus further decreasing the amount of moisture that may accumulate on the top surface.

In the present invention, the housing assemblies of a connector block are aligned in a vertically stacked orientation, rather than aligned in a horizontal direction as in electrical connector assembly 8. When the housing assemblies are aligned in a vertically stacked orientation, the conductor-receiving opening(s) of the housing assemblies are aligned along a vertical surface of the housing assembly. An opening which is positioned along a vertical surface of the housing assembly minimizes the potential for water to enter its respective housing because gravity may cause moisture to flow downwards, and when the opening is on a side of the connector block, the possibility of moisture entering the opening because of gravity is reduced. That is, moisture that originates from above the connector block may move downward because of gravity and when the opening is positioned on the side of the connector block, it is unlikely that the moisture will flow directly into the opening.

If electrical connector assembly 8 is rotated 180 degrees so that access cover opens in the opposite direction as that shown in FIG. 1 (flips “up”, rather than “down”), and access covers 20 in FIG. 1 are connected to their respective housings with a hinge, moisture may also enter the housing by way of entry points created by the access cover hinge. However, in the present invention, the access cover hinge (or other similar connections) would be along a side of the housing assembly, thus further reducing the number of housing entry points on the top surface of connector block 40.

The present invention may also increase visibility of the openings of each housing assembly, as compared to electrical connector assembly 8 of FIG. 1, because the openings are aligned along a vertical surface of the connector block. Openings that are aligned along a vertical surface of the connector block are accessible from the side of the connector block, rather than the top. In an electrical connector assembly of the present invention, even if the connector block is located at or near the bottom of the central location (or at or near the ground), a telecommunications worker does not have to be in a position to view the bottom of the connector block in order to view and/or access the openings. The telecommunications worker need only be able to view the side of the connector block.

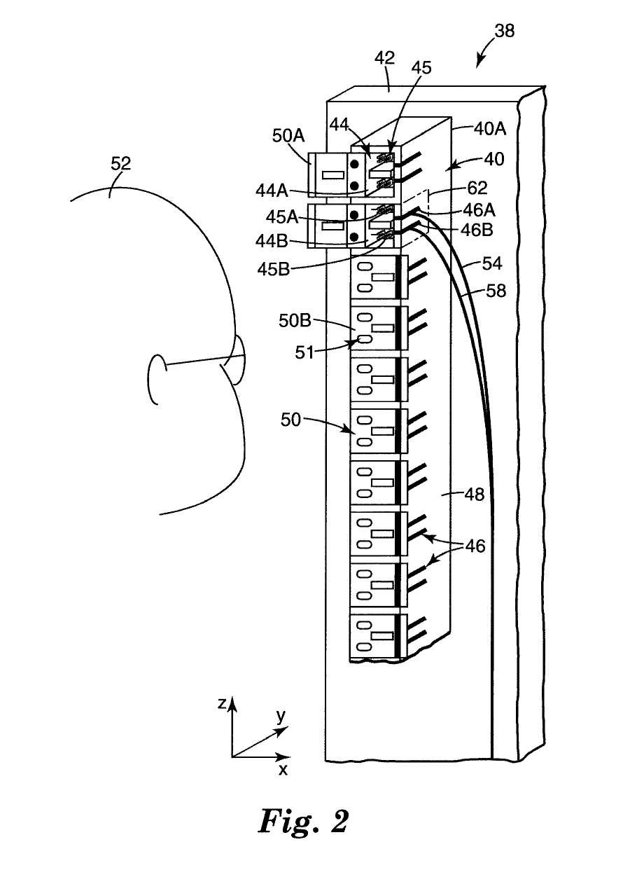

FIG. 2 shows an exemplary embodiment of electrical connector assembly 38 of the present invention, where connector block 40 is mounted on frame 42. Any suitable means of mounting connector block 40 to frame 42 may be used. Frame 42 may be mounted in a central location, and other connector blocks (not shown in FIG. 2) may also be mounted on frame 42. Frame 42 may be mounted to the central location using any suitable means. Each housing assembly of connector block 40 includes housings 44 aligned in a vertically stacked orientation, conductor-receiving openings 46, and access covers 50. The plurality of housing assemblies are also aligned in a vertically stacked orientation because housings 44 are aligned in a vertically stacked orientation. In accordance with the present invention, housings 44 are aligned in a vertical direction so that connector block 40 is elongated in the vertical direction. That is, the length connector block 40 extends along the vertical direction and connector block 40 has a greater dimension in the vertical direction than in the horizontal direction. The descriptive word, “elongated”, is specific to a rectangular-shaped connector block. The present invention also contemplates connector blocks of other shapes, but it would no longer be applicable to describe, for example, a square-shaped connector block as being “elongated” in the vertical direction. However, the housings of a square-shaped connector block may still be aligned in a vertical stacked orientation in accordance with the present invention. Orthogonal x-y-z coordinates are shown in FIG. 2 to provide a reference point for gauging the vertical direction (i.e., the z-coordinate direction). The depiction of a person 52 looking at electrical connector assembly 38 also provides a reference point.

In the embodiment shown in FIG. 2, two openings 46 correspond to each housing 44. However, each housing 44 may have any suitable number of openings 46, which typically depends upon the number of conductors the IDC element 45 located within each housing 44 is able to receive. “Housings 44” generally refers to the plurality of housings in connector block 40 and “openings 46” generally refer to the plurality of openings in connector block 40. Housings 44 include housing 44A and 44B, whose respective access covers 50 are in an open position 50A so that IDC elements 45 disposed within each housing 44A and 44B are exposed. Although housings 44A and 44B house two IDC elements 45 each, housings 44A and 44B, as well as the other housings 44, may each have any suitable number of IDC elements. Openings 46 include openings 46A and 46B, which are each capable of receiving a conductor. For example, opening 46A receives conductor 54, which contacts IDC element 45A in housing 44B, and opening 46B receives conductor 58, which contacts IDC element 45B in housing 44B.

As a result of the vertically stacked orientation of housings 44, openings 46 are aligned along vertical surface 48 of connector block 40 (or otherwise stated, openings 46 are aligned along a vertical surface of each of the housing assemblies, which include housings 44 and access covers 50). Openings 46 are positioned at a side of connector block 40, rather than the top, as with openings 16 of connector block 10 in electrical connector assembly 8 of FIG. 1, or rather than the bottom, as with openings 16 if connector block 10 was rotated 180 degrees from its position shown in FIG. 1.

A telecommunications worker may access openings 46 in order to be able to introduce a conductor into each of openings 46 to access one or more IDC elements 45 located within each of the respective housings 44. Because openings 46 are aligned along vertical surface 48, a conductor which is received in each of the openings 46 extends from its respective housing 44 in a horizontal (i.e., in the x and/or y-coordinate directions) and downward (i.e., in the z-coordinate direction) direction, thereby minimizing the potential for moisture which may accumulate around the conductor (e.g., area 62) to wick into the respective housing 44 by way of the conductor. Similarly, because openings 46 are positioned on vertical surface 48 (or a side of connector block 40), the possibility of moisture directly entering opening 46 because of gravity (i.e., moisture that enters housing 44B from the above connector block 40) is minimized.

The “horizontal and downward” positioning of the conductors as they leave their respective housings 44 is illustrated with conductors 54 and 58. Conductor 54 is received in opening 46A and connected to an IDC element 45A disposed in housing 44B, and conductor 58 is received in opening 46B and connected to an IDC element 45B disposed in housing 44B. Conductors 54 and 58 are only partially disposed in housing 44B because only an end portion of each conductor 54 and 58 is disposed in housing 44B and connected to IDC elements 45A and 45B, respectively, and a portion of each conductor 54 and 58 also extends away from housing 44B.

Conductors 54 and 58 extend from housing 44B in the horizontal direction because openings 46A and 46B, respectively, are positioned on the side of connector block 40. Conductors 54 and 58 also extend from housing 44B in a downward direction because as understood by those skilled in the art, the typical practice of a telecommunications worker when making cross connections between a subscriber block and a service provider block in the central location is to route conductors 54 and 58 so that the low point (i.e., the smallest z-coordinate) on each conductor 54 and 58 is found somewhere in the middle of the conductor 54 and 58, not at either end connected to a connector block. For example, conductors 54 and 58 may be routed from connector block 40 to the bottom of the central location before being routed to another block. This type of routing may be practiced for wire management purposes. This practice, when applied to the present invention, will permit each conductor 54 and 58 to extend from housing 44B, as well as the housing of the other connector block conductor 54 and 58 are connected to, in a downward direction, regardless of which end is located higher (i.e., has the greatest z-coordinate) in the central location.

While some moisture may still enter housing 44B, the present invention helps to minimize the amount of moisture that enters housing 44B due to gravity and/or the use of conductors 54 and 58 as a “wick” or a direct path into housing 44B. The positioning of conductors 54 and 58 no longer invites moisture to run along conductors 54 and 58 directly into housing 44B. Rather, at least some moisture will have a tendency to move generally down and away from housing 44B because of the downward slope of conductors 54 and 58 away from openings 46A and 46B, respectively, as they extend from housing 44B. Further, the positioning of openings 46A and 46B along the side of connector block 40 also helps to minimize the amount of moisture that enters housing 44B due to gravity.

Access covers 50 are pivotally connected to housings 44. Preferably, access covers 50 pivot with respect to their respective housings about a vertical axis (i.e., an axis along the z-coordinate direction). Even more preferably, access covers 50 pivot about a common vertical access. The pivotal connection may be a hinge. In an alternative embodiment, access covers 50 may be detachable from housings 44, rather than being pivotally connected. Each of the plurality of access covers 50 has an open position 50A and closed position 50B. In order to move between closed position 50B and open position 50A, each of the access covers 50 pivots sideways (e.g., in the x and y-coordinate directions for the embodiment shown in FIG. 2) about a vertical axis. When each of the plurality of access covers 50 is in an open position 50A, the telecommunications worker may access IDC elements 45 that are disposed within each respective housing 44.

A gel or other sealant material may also be added to each one of housings 44 prior to the closure of its respective access cover 50 to create a moisture seal within the housing when the respective access cover 50 closed. The sealant material will further help minimize the amount of moisture that will potentially enter each one of housings 44. The sealant materials include greases and gels, such as, but not limited to RTV® 6186 mixed in an A to B ratio of 1.00 to 0.95, available from GE Silicones of Waterford, N.Y.

Gels, which can be described as sealing material containing a three-dimensional network, have finite elongation properties, which allow them to maintain contact with the elements and volumes they are intended to protect. Gels, which are useful in this invention, may include formulations which contain one or more of the following: (1) plasticized thermoplastic elastomers such as oil-swollen Kraton triblock polymers; (2) crosslinked silicones including silicone oil-diluted polymers formed by crosslinking reactions such as vinyl silanes, and possibly other modified siloxane polymers such as silanes, or nitrogen, halogen, or sulfur derivatives; (3) oil-swollen crosslinked polyurethanes or ureas, typically made from isocyanates and alcohols or amines; (4) oil swollen polyesters, typically made from acid anhydrides and alcohols. Other gels are also possible. Other ingredients such as stabilizers, antioxidants, UV absorbers, colorants, etc. can be added to provide additional functionality if desired.

Useful gels will have ball penetrometer readings of between 5 g and 40 g when taken with a 0.25 inch diameter steel ball and a speed of 2 mm/sec to a depth of 4 mm in a sample contained in a cup such as described in ASTM D217 (3 in diameter and 2.5 in tall cylinder filled to top). Further, they will have an elongation as measured by ASTM D412 and D638 of at least 100%, and more preferred at least 350%. Also, these materials will have a cohesive strength, which exceeds the adhesive strength of an exposed surface of the gel to itself or a similar gel. Representative formulations include gels made from 3-15 parts Kraton G1652 and 90 parts petroleum oil, optionally with antioxidants to slow decomposition during compounding and dispensing.

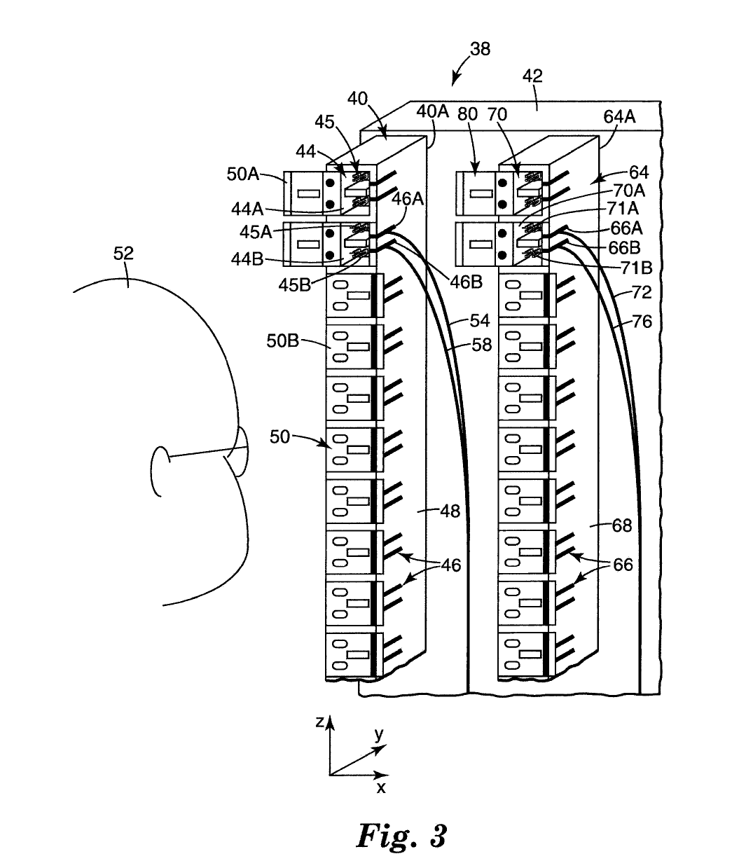

FIG. 3 shows the exemplary embodiment of FIG. 2, where electrical connector assembly 38 includes a second connector block 64 mounted on frame 42 adjacent connector block 40, thereby forming a “row” of connector blocks. Any suitable means of mounting connector block 64 to frame 42 may be used. Connector block 40 includes elongated edge 40A and connector block 64 includes elongated edge 64A. Connector blocks 40 and 64 are attached to frame 42 so that each elongated edge 40A and 64A extends in the vertical direction, and so that elongated edges 40A and 64A are generally parallel to each other.

Connector block 64 includes a plurality of housing assemblies which are each defined by one of the plurality of housings 70 and a respective access cover 80. Connector block 64 is mounted on frame 42 in a similar position as connector block 40, where openings 66 are positioned along generally vertical surface 68 of connector block 64, and housings 70 (and therefore, the housing assemblies of connector block 64) are positioned in a vertically stacked orientation. Housing 70A includes IDC elements 71A and 71B. Conductors 72 and 76 are connected to IDC elements 71A and 71B, respectively, and extend from their respective openings 66A and 66B in a horizontal and downward direction, similar to conductors 54 and 58 (shown in FIGS. 2 and 3, and described with respect to FIG. 2). Access covers 80 of connector block 64 are pivotally attached to their respective housings 70, and preferably pivot about a common vertical axis.

Electrical connector assembly 38 may further include any suitable number of additional connector blocks, which is defined by the needs of the user as well as the dimensional parameters of the central location electrical connector assembly 38 is mounted in. The additional connector blocks may also be mounted parallel to connector blocks 40 and 64 to form a row of connector blocks, and/or may also be mounted in an additional row which is mounted parallel to the row shown in FIG. 3, thereby forming a grid of connector blocks.

Similar to housings 44, a gel or other sealant material may also be added to each one of housings 70 prior to the closure of its respective access cover 80 to create a moisture seal within the housing when the access cover closed.

The present invention also includes a method of forming an electrical connector assembly in accordance with the present invention. The method includes providing a first connector block and a suitable frame for receiving the first connector block and attaching the connector block to the frame. The first connector block includes a plurality of housing assemblies and is preferably mounted so that the plurality of housing assemblies are aligned in a generally vertically stacked orientation. Additional connector blocks may also be mounted adjacent and generally parallel to the first connector block.

The present invention is described in reference to the first embodiment. However, the description of the first embodiment is partially applicable to the second embodiment. In the second embodiment, a conductor-receiving opening is positioned along a vertical surface of the access cover (e.g., opening 51 in FIG. 2), rather than along a vertical surface of the housing. The inventive aspects of the first embodiment and second embodiment are similar. In both embodiments, the housing assemblies are aligned in a vertically stacked orientation, and the conductor-receiving openings of the connector block are also aligned along a generally vertical surface of the housing assembly.

The depiction of the connector blocks and electrical connector assemblies in the figures are for clarity of illustration and are merely used as aids to describe the present invention. Details of the connector blocks have been left out of FIGS. 1-3 for clarity of illustration. The present invention may be used with any suitable type of connector blocks, not only connector blocks that resemble the connector blocks shown in FIGS. 1-3. For example, a connector block may have a different shape than that shown in FIGS. 2-3, such as a square shape. Furthermore, the IDC elements shown in connector blocks 10, 40, and 64 are merely representative of IDC elements, and are not intended to limit the present invention in any way. Any suitable type of IDC element may be used in an electrical connection assembly of the present invention.

Examples of suitable connector blocks that may be used in accordance with the present invention are described in U.S. patent application Ser. No. 10/941,506, entitled, “INSULATION-DISPLACEMENT SYSTEM FOR TWO ELECTRICAL CONNECTORS”, and filed on Sep. 15, 2004, U.S. patent application Ser. No. 10/941,441, entitled, “CONNECTOR ASSEMBLY FOR HOUSING INSULATION DISPLACEMENT ELEMENTS”, and filed on Sep. 15, 2004, U.S. Pat. No. 6,406,324, issued on Jun. 18, 2002 and entitled, “INSULATION DISPLACEMENT CONNECTOR TERMINAL BLOCK”, and U.S. Pat. No. 6,254,421, issued on Jul. 3, 2001 and entitled, “CONNECTOR ASSEMBLY HAVING PIVOTING WIRE CARRIER WITH POSITION DETENTS”.

Frame 42 (FIGS. 2 and 3) is a general depiction frame and is not intended to limit the present invention in any way. Electrical connector assemblies according to the present invention may include any suitable types of frames for mounting a connector block, and not just frames that resemble frame 42. For example, a suitable frame for use in connection with the present invention is described in U.S. patent application Ser. No. XX/XXX,XXX, entitled, “FRAME ASSEMBLY”, and filed on the same day as the present application. Furthermore, in alternate embodiments, a connector block may be mounted directly to the central location in an electrical connector assembly of the present invention.

Although the present invention is only described with respect to the telecommunications industry, other applications of a connector block or an electrical connector assembly in accordance with the present invention are contemplated. Likewise, although the present invention has been described with reference to preferred embodiments, workers skilled in the art will recognize that changes may be made in form and detail without departing from the spirit and scope of the invention.

1. An electrical connector assembly comprising a connector block, the connector block comprising:
a plurality of housing assemblies, each housing assembly comprising:
a housing, wherein the housing comprises an insulation displacement connector element disposed within the housing, wherein the insulation displacement connector element is adapted to electrically connect with a conductor partially disposed within the housing;
an access cover, wherein the access cover is connected to the housing, the access cover being moveable between a closed position and an open position, wherein in the open position, the insulation displacement connector disposed within the housing is accessible;
a generally vertical surface; and
a conductor-receiving opening along the generally vertical surface of the housing assembly; and wherein
the plurality of housing assemblies are aligned in a generally vertically stacked orientation and are mounted to at least one frame positioned in a central location.

2. The electrical connector assembly of claim 1, wherein each access cover pivots with respect to its respective housing.

3. The electrical connector assembly of claim 2, wherein each access cover pivots about a common generally vertical axis.

4. The electrical connector assembly of claim 1, and further comprising a plurality of connector blocks each including a plurality of housing assemblies, wherein the plurality of connector blocks are aligned with respect to each other in a generally horizontal direction, and further wherein the generally vertical surface of each housing assembly of each connector block is generally parallel to the generally vertical surface of each housing assembly of an adjacent connector block.

5. The electrical connector assembly of claim 1, wherein a sealant material is disposed within each housing of the plurality of housing assemblies.

6. An assembly for connecting at least two electrical conductors, the assembly comprising:
a frame positioned in a central location;
a first insulation displacement connector block including a first elongated edge, wherein the first insulation displacement connector block is attached to the frame such that the first elongated edge extends in a generally vertical direction; and
a second insulation displacement connector block including a second elongated edge, wherein the second insulation displacement connector block is attached to the frame such that the second elongated edge extends in the generally vertical direction, and wherein the first elongated edge of the first connector block is generally parallel to the second elongated edge of the second connector block.

7. The assembly of claim 6, wherein the first and second insulation displacement connector blocks each comprise:
a plurality of housing assemblies, each housing assembly comprising:
a housing, wherein the housing comprises an insulation displacement connector element disposed within the housing, wherein the insulation displacement connector element is adapted to electrically connect with a conductor partially disposed within the housing;
an access cover, wherein the access cover is connected to the housing, the access cover being moveable between a closed position and an open position, wherein in the open position, the insulation displacement connector disposed within the housing is accessible;
a generally vertical surface; and
a conductor-receiving opening along the generally vertical surface of the housing assembly; and wherein
the plurality of housing assemblies are aligned in a generally vertically stacked orientation

8. The assembly of claim 7, wherein each access cover pivots with respect to its respective housing.

9. The assembly of claim 8, wherein each access cover pivots about a common generally vertical axis.

10. The assembly of claim 7, wherein a sealant material is disposed within each housing of the plurality of housing assemblies.

11. A method of forming an electrical connector assembly, the method comprising:
providing a first connector block, the first connector block including:
a first generally vertical surface;
a plurality of conductor-receiving opening along the first generally vertical surface;
a plurality of housings aligned in a generally vertically stacked orientation;
an insulation displacement connector element disposed within each housing, wherein the insulation displacement connector is adapted to electrically connect with a conductor partially disposed within its respective housing; and
a plurality of access covers, wherein each access cover is connected to at least one of the plurality of housings, each access cover being moveable between a closed position and an open position, wherein in the open position, the insulation displacement connector disposed within the housing connected to the access cover is accessible;
providing a frame for receiving the first connector block; and
attaching the first connector block to the frame.

12. The method of claim 11, wherein each housing forms a portion of the first generally vertical surface of the first connector block.

13. The method of claim 11, wherein each access cover forms a portion of the first generally vertical surface of the first connector block.

14. The method of claim 11, wherein each access cover pivots with respect to its respective housing.

15. The method of claim 14, wherein each access cover pivots about a common generally vertical axis.

16. The method of claim 11, and further comprising the step of mounting a second connector block adjacent the first connector block, the second connector block including a second generally vertical surface, wherein the first and second generally vertical surfaces are parallel.

17. The method of claim 16, wherein the second connector block comprises:
a second generally vertical surface;
a plurality of conductor-receiving openings along the second generally vertical surface;
a plurality of housings aligned in a generally vertically stacked orientation;
an insulation displacement connector element disposed within each housing, wherein the insulation displacement connector is adapted to electrically connect with a conductor partially disposed within each respective housing; and
a plurality of access covers, wherein each access cover is connected to at least one of the plurality of housings, each access cover being moveable between a closed position and an open position, wherein in the open position, the insulation displacement connector disposed within the housing connected to the access cover is accessible.
